(19) United States
(12) Patent Application Publication
(10) Pub. No.: US 2026/0220835 A1
(43) Pub. Date: Jul. 30, 2026

(54) GENERATING BRUSHSTROKES WITH GRAVITY-BASED FLUID FLOW

(71) Applicant: Adobe Inc., San Jose, CA (US)

(72) Inventors: Axel Florent Jacques Paris, Paris (FR); Zoe Lola Salomé Herson, Paris (FR); Élie Louis Simon Michel, Paris (FR)

(73) Assignee: Adobe Inc., San Jose, CA (US)

(21) Appl. No.: 19/041,203

(22) Filed: Jan. 30, 2025

(51) Int. Cl. G06T 11/20; G06T 11/00

(52) U.S. Cl. CPC G06T 11/23; G06T 11/10; G06T 2200/24; G06T 2210/24

(57) ABSTRACT

In implementation of techniques for generating brushstrokes with gravity-based fluid flow, a computing device implements a fluid flow system to receive an input stroke on a virtual canvas. The fluid flow system determines a gravity feature involving simulated fluid interaction with the virtual canvas using an algorithm based on a geometry of the virtual canvas. Based on the gravity feature, the fluid flow system generates a brushstroke based on a shape of the input stroke and that simulates fluid interaction on the virtual canvas. The fluid flow system then presents the brushstroke on the virtual canvas in a user interface.

### BACKGROUND

Painting applications facilitate generation of computer graphics including detailed artwork for display in a user interface or for printed media. The painting applications involve receiving virtual paint strokes that together form a virtual painting. However, the virtual strokes are typically uniform and appear computer-generated. For instance, the virtual paint strokes lack imperfections that contribute to an organic aesthetic that is typical of real-life painting. Because of this, the painting applications result in visual inaccuracies, errors, and computational inefficiencies in real world scenarios.

### SUMMARY

Techniques and systems for generating brushstrokes with gravity-based fluid flow are described. In an example, a fluid flow system receives an input stroke on a virtual canvas.

The fluid flow system determines a gravity feature involving simulated fluid interaction with the virtual canvas using an algorithm based on a geometry of the virtual canvas. For example, the geometry of the virtual canvas describes a texture, and the fluid interaction on the virtual canvas is based on the texture. In some examples, the gravity feature is based on an input selection of a texture type for the virtual canvas. Further, in some examples the gravity feature is based on an input selection of an orientation for the virtual canvas. Additionally, some examples involve generating a gravity map describing effects of the gravity feature related to sections of the virtual canvas.

Based on the gravity feature, the fluid flow system generates a brushstroke based on a shape of the input stroke and that simulates fluid interaction on the virtual canvas. In some examples, the fluid interaction on the virtual canvas involves determining simulated surface tension of fluid on the virtual canvas. For example, the fluid interaction on the virtual canvas is based on properties of an input selection of a virtual fluid for the input stroke. Further, in some examples the fluid interaction on the virtual canvas involves determining simulated dripping of virtual fluid based on the gravity feature. The fluid flow system then presents the brushstroke on the virtual canvas in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for generating brushstrokes with gravity-based fluid flow as described herein.

FIG. 2 depicts a system in an example implementation showing operation of a mesh progression module for generating brushstrokes with gravity-based fluid flow.

FIG. 3 depicts an example of receiving an input including a stroke on a virtual canvas.

FIG. 4 depicts an example of determining a gravity feature involving fluid interaction with the virtual canvas.

FIG. 5 depicts an example of generating a brushstroke based on the gravity feature and texture of the virtual canvas.

FIG. 6 depicts an example of generating a brushstroke based on the gravity feature and an orientation of the virtual canvas.

FIG. 7 depicts a procedure in an example implementation of generating brushstrokes with gravity-based fluid flow.

FIG. 8 depicts a procedure in an additional example implementation of generating brushstrokes with gravity-based fluid flow.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Painting applications allow for generation of detailed artwork in computer graphics. The painting applications, for instance, provide multiple selectable options for brush size and paint color, as well as receive input strokes from a user painting on a virtual canvas. However, the painting applications are limited to creating strokes with smooth edges that have little visual variance. This is problematic when the user desires to create artwork that has an appearance of watercolor art. In real-life examples, watercolor paint is water-based and therefore results in imperfect fluid flow on paper or canvas. For instance, the watercolor paint flows around bumps and into divots that are part of a texture of a canvas, and drips depending on an orientation of the canvas in real-life. These imperfections are sought-after by artists who desire the convenience of virtual painting on a virtual canvas using a painting application, while retaining the realistic look of watercolor paint.

Conventional fluid simulation techniques are capable of simulating fluid flow based on fast-moving fluids or temperature-dependent flow for thick liquids. However, fluid speed and temperature are irrelevant to simulating watercolor brushstrokes, which involve thin liquid layers, and the conventional fluid simulation techniques therefore are not applicable to generating realistic brushstrokes in a user interface. Accordingly, the conventional fluid simulation techniques fail to mimic the fluid flow of watercolor paint in a virtual environment.

Techniques and systems are described for generating brushstrokes with gravity-based fluid flow that overcome these limitations. For instance, a gravity feature is determined that is relevant to how fluid interacts with a virtual canvas to generate a brushstroke that mimics the appearance of watercolor paint. By generating a brushstroke based on the gravity feature, the brushstroke is configured to mimic realistic fluid flow based on simulated texture of the canvas that gives the appearance of watercolor paint and cannot be replicated by the existing physics-based models. In contrast, the conventional fluid simulation techniques do not simulate gravity-related effects, including dripping, and therefore fail to generate brushstrokes that mimic the appearance of watercolor paint.

A fluid flow system begins in this example by receiving an input including a stroke on a virtual canvas displayed in a user interface. The stroke indicates an intended brushstroke for display in the user interface and is input via a swipe, drag, tap, or other gesture relative to the virtual canvas displayed in the user interface. The virtual canvas, for instance, is a designated portion of the user interface for virtually drawing or painting digital media.

The fluid flow system is configured to determine a gravity feature based on a canvas texture type in this example. The canvas texture type describes a type of virtual texture represented on the virtual canvas. Although the canvas texture type affects how simulated fluid (e.g., watercolor paint) interacts with the virtual canvas, the texture of the virtual canvas is visible or invisible, depending on a user input selection in some examples. The fluid flow system leverages an algorithm to determine the gravity feature, which describes how fluid flows relative to regions of the virtual canvas based on the canvas texture type and/or an orientation of the virtual canvas. Because the virtual canvas in this example is a virtually-represented in the user interface, in some examples the fluid flow system receives an additional input specifying the orientation of the virtual canvas or a canvas texture type for the virtual canvas. Therefore, in some examples, the fluid flows around bumps, into divots, or drips down the surface of the virtual canvas when the virtual canvas is tilted or positioned upright.

The fluid flow system is also configured to generate a brushstroke based on the gravity feature. For example, the brushstroke visually simulates fluid interaction on the virtual canvas based on the gravity feature. To do so, the fluid flow system uses the algorithm to determine simulated fluid flow for a boundary of the brushstroke based on the gravity feature. For example, the fluid flow system analyzes the gravity feature and predicts behavior for fluid dripping, flowing, and spreading across the virtual canvas incident to the stroke.

The fluid flow system then generates an output including the brushstroke. The brushstroke has an overall shape of the stroke, with a boundary edge that mimics realistic fluid flow based on the texture or the orientation of the virtual canvas, including how the simulated fluid drips, flows, and spreads across the virtual canvas. The brushstroke, for example, has an appearance of being hand-painted using watercolor paint.

Generating brushstrokes with gravity-based fluid flow in this manner overcomes the limitations of conventional fluid simulation techniques that are missing a gravity factor and therefore fail to generate brushstrokes that mimic the appearance of watercolor paint. For example, determining a gravity feature that is relevant to how fluid interacts with a virtual canvas results in generation of a realistic brushstroke that has an aesthetic of watercolor paint. For these reasons, generating brushstrokes with gravity-based fluid flow is more accurate and produces more aesthetically pleasing results than the conventional fluid simulation techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

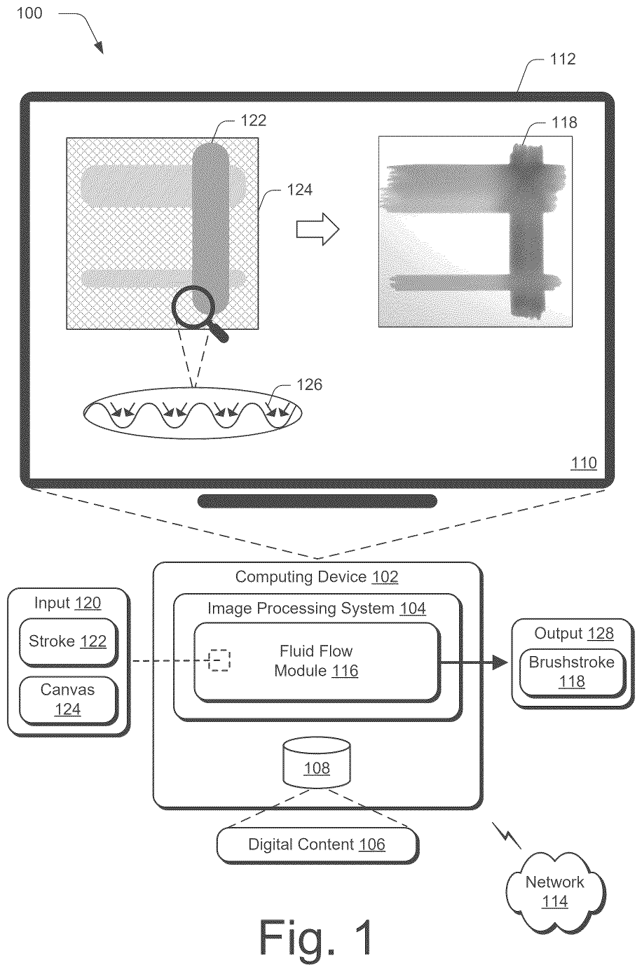

FIG. 1 is an illustration of a digital medium environment 100 in an example implementation that is operable to employ techniques and systems for generating brushstrokes with gravity-based fluid flow described herein. The illustrated digital medium environment 100 includes a computing device 102, which is configurable in a variety of ways.

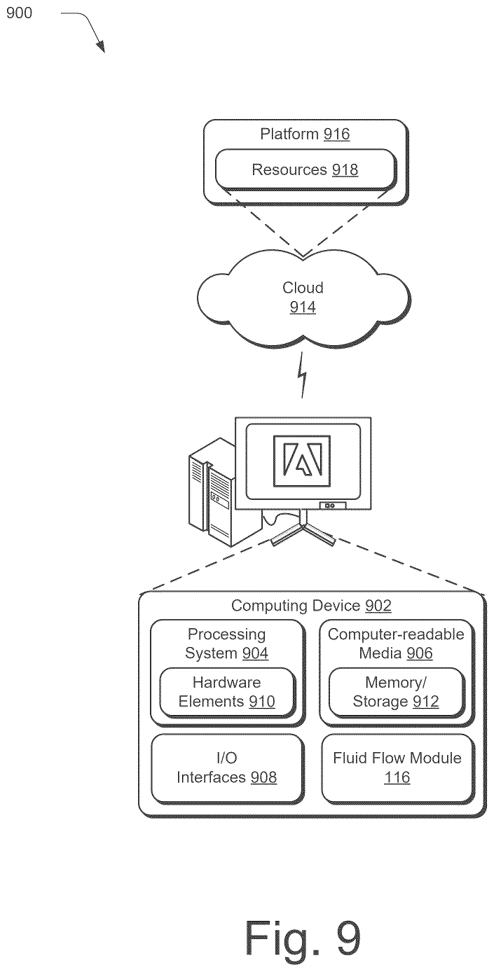

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 9.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a fluid flow module 116 which is illustrated as incorporated by the image processing system 104 to process the digital content 106. In some examples, the fluid flow module 116 is separate from the image processing system 104 such as in an example in which the fluid flow module 116 is available via the network 114.

The fluid flow module 116 is configured to generate a brushstroke 118 that mimics an aesthetic of a watercolor paint brushstroke. For example, the fluid flow module 116 first receives an input 120 including a stroke 122 on a canvas 124. The stroke 122, for instance, is input from a touch, drag, draw, or other input via interaction with a touch display device or a non-touch display device. Here, the stroke 122 indicates a portion of a drawing that is desired to be rendered in a watercolor paint aesthetic. The canvas 124 is a virtual painting or drawing surface that includes simulated texture. In this example, for instance, the texture is a virtual representation of watercolor paper, or other textured surface. The texture of the canvas 124 includes various dumps and divots that contribute to an uneven surface of the canvas 124.

Because the texture of the canvas 124 results in uneven brushstroke edges and/or dripping in real-life scenarios, the fluid flow module 116 mimics the real-life brushstroke aesthetic based on a geometry of the canvas 124, which involves the texture or an orientation of the canvas 124. To do so, the fluid flow module 116 determines a gravity feature 126 related to the canvas 124 based on the texture or the orientation of the canvas 124. The gravity feature 126 describes how fluid flows relative to regions of the canvas 124 based on the texture and/or the orientation of the canvas 124. In some examples, for instance, the fluid flows around bumps, into divots, and/or drips down the surface of the canvas 124 when the canvas 124 is tilted or positioned upright. Because the canvas 124 in this example is a virtually-represented canvas, in some examples the fluid flow module 116 receives an additional input specifying the orientation of the canvas 124 and/or a canvas texture type for the canvas 124.

The fluid flow module 116 generates the brushstroke 118 based on the stroke 122 and the gravity feature 126. For example, the fluid flow module 116 uses an algorithm configured to determine simulated fluid flow for a boundary edge of the brushstroke 118 based on the gravity feature 126. The brushstroke 118 has an overall shape of the stroke 122, and the boundary edge mimics realistic fluid flow based on the texture and/or the orientation of the canvas 124, including how the simulated fluid drips, flows, and spreads across the canvas 124 around the brushstroke 118. The brushstroke 118, for example, has an appearance of being hand-painted using watercolor paint.

The fluid flow module 116 then generates an output 128 including the brushstroke 118, further examples of which are described in the following sections and shown in corresponding figures. For example, the brushstroke 118 is displayed in the user interface 110, with or without the texture of the canvas 124 visible. The brushstroke 118 is then further incorporated into additional media in some examples.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Generating Brushstrokes with Gravity-Based Fluid Flow

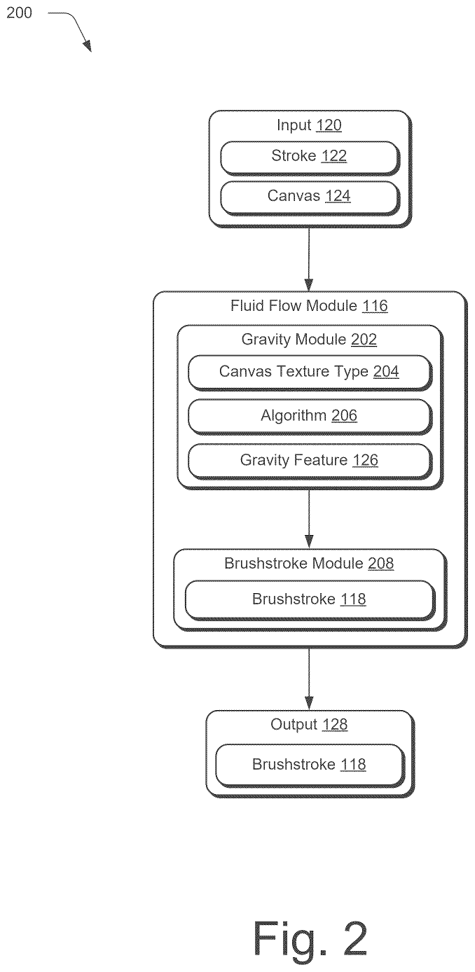

FIG. 2 depicts a system 200 in an example implementation showing operation of the fluid flow module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-9.

To begin in this example, a fluid flow module 116 receives an input 120 including a stroke 122 on a canvas 124. The stroke 122, for instance, is a marker or other indicator of an input gesture correlating to a drawing motion via a user interface 110. The stroke 122 is input relative to the canvas 124, which is a designated portion of the user interface 110 for virtually drawing or painting digital media. Additionally, the stroke 122 in some examples involves a draft stroke displayed in the user interface 110 indicating an outline or path corresponding to the stroke 122. The draft stroke, for instance, represents an overall shape of the stroke 122 for edge editing to generate the brushstroke 118.

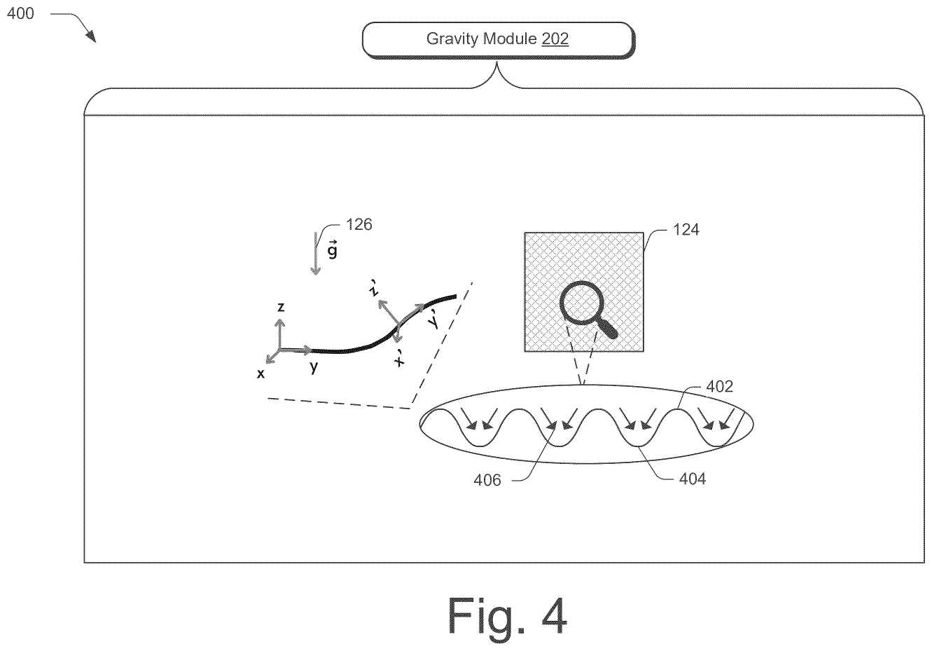

The fluid flow module 116 includes a gravity module 202. The gravity module 202 is configured to determine a gravity feature 126 based on a canvas texture type 204 in this example. The canvas texture type 204 describes a type of virtual texture represented on the canvas 124. Although the canvas texture type 204 affects how simulated fluid (e.g., watercolor paint) interacts with the canvas 124, the texture of the canvas 124 is visible or invisible in some examples. The gravity module 202 leverages an algorithm 206 to determine the gravity feature 126, explained in further detail with respect to FIG. 4 below. For example, the gravity feature 126 describes how fluid flows relative to regions of the canvas 124 based on the canvas texture type 204 and/or an orientation of the canvas 124. In some examples, for instance, the fluid flows around bumps, into divots, and/or drips down the surface of the canvas 124 when the canvas 124 is inclined, tilted, or positioned upright. Because the canvas 124 in this example is a virtually-represented canvas, in some examples the fluid flow module 116 receives an additional input specifying the orientation of the canvas 124, an angle of incline of the canvas, and/or a canvas texture type for the canvas 124, as selected by a user.

The fluid flow module 116 also includes a brushstroke module 208 that is configured to generate a brushstroke 118 based on the gravity feature 126. For example, the brushstroke 118 simulates fluid interaction on the canvas 124 based on the gravity feature 126. To do so, the fluid flow module 116 uses the algorithm 206 configured to determine simulated fluid flow for a boundary of the brushstroke 118 based on the gravity feature 126. For example, the brushstroke module 208 analyzes the gravity feature 126 and predicts behavior for fluid dripping, flowing, and spreading across the canvas 124 incident to the stroke 122.

In some examples, the algorithm 206 is a machine learning model trained to determine the gravity feature 126 and to generate the brushstroke 118 based on the gravity feature 126. For example, the machine learning model is trained on real-life examples of fluid flow related to different pigments, including watercolor paint, on different canvas types. For instance, the different canvas types have different geometries, including texture and/or orientation. By observing fluid flow behavior on the different canvas types, the machine learning model is trained to predict the brushstroke 118 for the gravity feature 126 corresponding to the different canvas types.

The fluid flow module 116 then generates an output 128 including the brushstroke 118. The brushstroke 118 has an overall shape of the stroke 122, with a boundary that mimics realistic fluid flow based on the texture and/or the orientation of the canvas 124, including how the simulated fluid drips, flows, and spreads across the canvas 124. The brushstroke 118, for example, has an appearance of being hand-painted using watercolor paint.

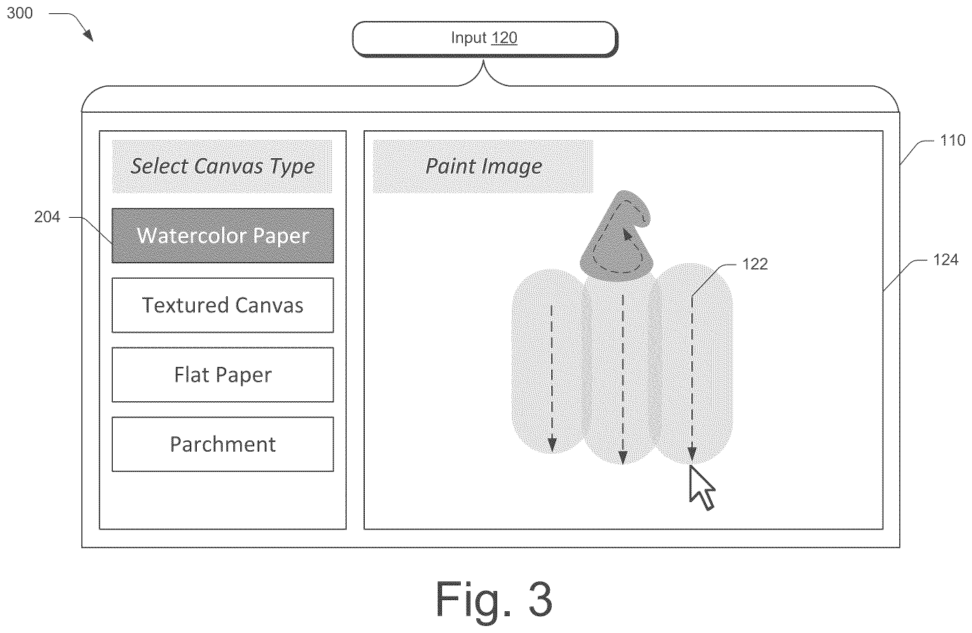

FIGS. 3-6 depict stages of generating brushstrokes with gravity-based fluid flow. In some examples, the stages depicted in these figures are performed in a different order than described below.

FIG. 3 depicts an example 300 of receiving an input including a stroke on a virtual canvas. As illustrated, the fluid flow module 116 receives an input 120 including a stroke 122 on a canvas 124. In this example, the stroke 122 is a paint stroke that is part of a virtual painting of a pumpkin. The virtual painting in this example includes multiple strokes of various shapes, sizes, and colors received as input as part of a drawing application. The user interface 110, for instance, displays a canvas 124 configured for drawing or painting, in addition to various selectable colors and widths for drawing or painting the stroke 122. For example, the stroke 122 corresponds to a swipe, tap, drag, or other motion received via a touch screen display, an analog mouse, or other computing input mechanism.

In this example, the user interface 110 is also configured to present choices for, and to receive a selection of a canvas texture type 204. The canvas texture type 204 indicates a virtual textured drawing or painting surface for input of the stroke 122. As illustrated in this example, choices for the canvas texture type 204 include watercolor paper, textured canvas, flat paper, and parchment, as presented in the user interface 110. The input 120 in this example includes a selection of the watercolor paper for the canvas texture type 204. In some examples, the fluid flow module 116 is also configured to present choices for, and to receive selections of different fluid-based pigments for generation of the brushstroke 118, including watercolor paint or other types of pigments. For instance, different fluids have different levels of absorbency that affect flow.

Additionally, in this example the input 120 includes an instruction to generate strokes that have the appearance of watercolor paint or other fluid-based pigment. For example, the stroke 122 currently has a shape with smooth edges that approximately correspond to a line drawn by a user on the user interface 110. However, the user desires the stroke 122 to have an organic appearance that simulates watercolor paint, which is characterized by having flowing, uneven edges. This is because watercolor paint is water-based and therefore flows unevenly on a painting surface, influenced by texture and/or an orientation of the painting surface. Therefore, in some examples, the 120 receives an indication to transform the stroke 122 into the brushstroke 118 in the user interface 110.

FIG. 4 depicts an example 400 of determining a gravity feature involving fluid interaction with the virtual canvas. FIG. 4 is a continuation of the example described in FIG. 3. After receiving the input 120 including the stroke 122 on the canvas 124, the gravity module 202 of the fluid flow module 116 determines a gravity feature 126 involving fluid interaction with the canvas 124.

To determine the gravity feature 126, the gravity module 202 uses an algorithm 206 configured to analyze geometry of the canvas 124 to determine a gravity map corresponding to the canvas 124. The canvas 124 in this example includes bumps 402, divots 404, and other textural features that contribute to an uneven surface of the canvas 124. A flow direction 406 is influenced by the bumps 402 and the divots 404 because fluid characteristically flows around the bumps 402 and into the divots 404. The gravity map, for instance, depicts the flow direction 406 relative to the bumps 402, the divots 404, or geometry and texture of the canvas 124.

Because the algorithm 206 is configured to determine the gravity feature 126 related to fluid flow that simulates watercolor paint, the algorithm 206 is based on slow laminar flows, which are flows that lack turbulence and mimic flowing watercolor paint. The algorithm 206 is also referred to as the Thin Fluid Equation, which is partially derived from a Navier-Stokes equation, with an additional gravity term:

$$\frac{\partial h}{\partial t} = \frac{ρ g}{3 μ} \vec{∇} [ {h}^{3} ( - \frac{γ}{ρ g} \vec{∇} {∇}^{2} h - {g}_{z}^{*} \vec{∇} h - \frac{3}{8} h \vec{∇} {g}_{z}^{*} - {g}_{xy}^{*} ) ]$$

The addition of the gravity vector allows the algorithm 206 to model the flow on small deformations of the surface, and thus account for medium influence.

Additionally, the equation is re-written to make it non-dimensional. To do so, equation is scaled to make it dimensionless, including scaling the height of the fluid h by h_{c}, the height of the fluid far behind the front:

$${h}^{*} = \frac{h}{{h}_{c}} .$$

The horizontal dimensions (x,y,z) are also scaled by a parameter called

$${x}_{c} : ( {x}^{*} , {y}^{*} , {z}^{*} ) = ( \frac{x}{{x}_{c}} , \frac{y}{{x}_{c}} , \frac{z}{{x}_{c}} ) .$$

This is re-written as

$${t}^{*} = \frac{t}{{t}_{c}} .$$

In order to derive the thin fluid equation,

$$\frac{{h}_{c}}{{x}_{c}} = ϵ ≪ 1.$$

An additional dimensionless parameter is

$$η = \frac{a}{{h}_{c}} ,$$

with the parameter a being the capillary length

$$a = \sqrt{\frac{γ}{ρ g}} .$$

The capillarity length balances the capillary force with the gravity force.

A velocity scale is defined as

$${u}_{c} = \frac{{x}_{c}}{{t}_{c}} ,$$

and another physical parameter, with the dimensionless capillary number is

$$Ca = \frac{μ {u}_{c}}{γ} .$$

The capillary number balances viscosity forces with the capillary forces. By replacing h, (x,y,z) and t by their nondimensional values, the following equation is derived (the h* notation is dropped for clarity):

$$\frac{\partial h}{\partial t} = \frac{1}{3 Ca {η}^{2}} \vec{∇} [ {h}^{3} ( - {η}^{2} {ϵ}^{3} \vec{∇} {∇}^{2} h - ϵ {g}_{z}^{*} \vec{∇} h - \frac{3}{8} h \vec{∇} {g}_{z}^{*} - \vec{{g}_{xy}^{*}} ) ]$$

This results in a set of three parameters for interpretation.

Conventional physics techniques primarily focus on precise modeling of wave instabilities and of higher Reynolds Number flows. When considering problems including fingering instability and low Reynolds numbers, the conventional physics techniques take the gravity vector as a constant and consider a fixed, non-zero inclination angle. In contrast to the conventional physics techniques, generating brushstrokes with gravity-based fluid flow involves a gravity vector, and thus is expressed as \vec{g}=g sin(α)\vec{e_{y}}−g cos(α)\vec{e}_{z}, with α the constant inclination angle, which results in the following equation:

$$\frac{\partial h}{\partial t} = \frac{1}{3 μ} \vec{∇} [ {h}^{3} ( - γ \vec{∇} {∇}^{2} h + ρ g cos ( α ) \vec{∇} h - ρ g sin ( α ) {\vec{e}}_{y} ) ]$$

Scaling rules are then identified such that h_{c}, x_{c}, and t_{c} are dependent of each other. For example, the scaling rules are chosen such that the different terms of the equation are of the same order of magnitude. In this case

$${x}_{c} = {( \frac{{a}^{2} {h}_{c}}{sin ( α )} )}^{1 / 3} and {t}_{c} = \frac{3 μ}{γ} \frac{{a}^{2} {x}_{c}}{{h}_{c}^{2} sin ( α )} .$$

The equation for the algorithm 206 is then written as:

$$\frac{\partial h}{\partial t} = \vec{∇} [ {h}^{3} \vec{∇} {∇}^{2} h ] + {( 3 Ca )}^{1 / 3} cot ( α ) \vec{∇} [ {h}^{3} \vec{∇} h ] - \vec{∇} {h}^{3} \cdot \vec{y}$$

The gravity feature 126 in this example indicates gravity forces influencing fluid flow relative to the bumps 402 and the divots 404 of the canvas 124. For instance, the gravity map indicates the flow direction 406 around the bumps 402 and into the divots 404 on the canvas 124. In some examples, the gravity map includes a visual field or arrows that indicate the flow direction 406, which influences the generation of the brushstroke 118, as discussed below.

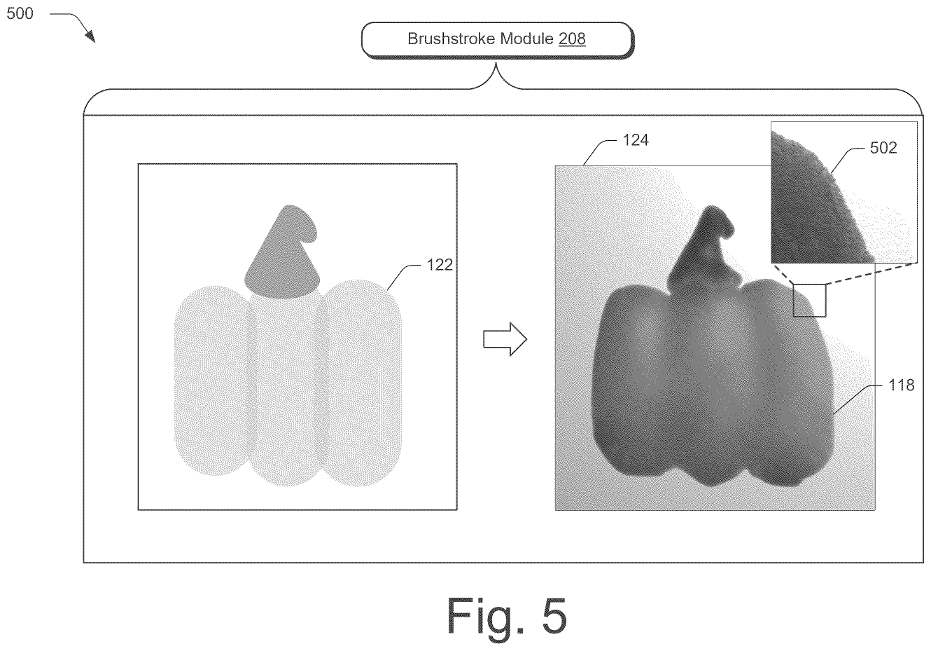

FIG. 5 depicts an example 500 of generating a brushstroke based on the gravity feature and texture of the virtual canvas. FIG. 5 is a continuation of the example described in FIG. 4. After determining a gravity feature 126, the fluid flow module 116 uses a brushstroke module 208 to generate a brushstroke 118 based on a shape of the stroke 122 that simulates fluid interaction on the canvas 124 based on the gravity feature 126.

Watercolor paint has a distinct aesthetic that is mimicked by the brushstroke 118, generated the brushstroke module 208. For example, watercolor paint is affected by interaction between a canvas and water-based paint. The canvas is made of cellulose fibers that absorb water and has small bumps and divots, creating a complex surface. This leads to anisotropic flow of the water in the watercolor paint, and accumulation of pigments in the divots or other hollows in the canvas. This interaction is mimicked by the brushstroke module 208 on a virtual version of the canvas, which replaces clean, straight edges of the stroke 122 with a flow edge 502, as part of the brushstroke 118.

To generate the brushstroke 118 including the flow edge 502, the brushstroke module 208 uses the algorithm 206, which considers a surface with small variation of its height with regard to its dimensions. The gravity vector is expressed in the local coordinates of the canvas 124 (\vec{e}ₓ,\vec{e}_{y},\vec{e}_{z}) \vec{g}=gₓ\vec{e}ₓ+g_{y}\vec{e}_{y}+g_{z}\vec{e}_{z}. Considering another point of the canvas, the local coordinate vectors have a priori a slightly different inclination

$$( {\vec{e}}_{x}^{′} , {\vec{e}}_{y}^{′} , {\vec{e}}_{z}^{′} ) .$$

The gravity vector is then expressed such that

$$\vec{g} = {g}_{x}^{′} {\vec{e}}_{x}^{′} + {g}_{y}^{′} {\vec{e}}_{y}^{′} + {g}_{z}^{′} {\vec{e}}_{z}^{′} .$$

Because the physical quantities are expressed in the local space, the variation of height of the canvas translates into a variation of direction for the gravity vector. To compute the new coordinates of \vec{g}, a rotation matrix M is used such that \vec{g}′=M\vec{g}. With the height map associated to the canvas, the matrix M is obtained by computing the coordinates of the local base

$$( {\vec{e}}_{x}^{′} , {\vec{e}}_{y}^{′} , {\vec{e}}_{z}^{′} )$$

in the global canvas base (\vec{e}ₓ,\vec{e}_{y},\vec{e}_{z}).

An explicit Euler scheme is used for solving the equations. Two discrete operators are listed below, for example, Δx denotes the spatial discretization step, and the discrete gradient \vec{∇}h and Laplacian ∇²h of the fluid height field h are defined as:

$$Gradient : \vec{∇} h = \frac{\partial h}{\partial x} {\vec{e}}_{x} + \frac{\partial h}{\partial y} {\vec{e}}_{y} = \frac{1}{2 Δ x} ( h [ x + 1 , y ] - h [ x - 1 , y ] , h [ x , y + 1 ] - h [ x , y - 1 ] )$$

$$Laplacian : {∇}^{2} h = \frac{{\partial }^{2} h}{\partial {x}^{2}} + \frac{{\partial }^{2} h}{\partial {y}^{2}} = \frac{1}{Δ {x}^{2}} ( h [ x + 1 , y ] + h [ x - 1 , y ] + h [ x , y + 1 ] + h [ x , y - 1 ] - 4 h [ x , y ] )$$

The quantities of the equation are computed by combining these two discrete operators. For a given simulation step, the implementation first fetches the neighboring values and stores them in local arrays for efficiency. Then, the different terms of the differential equation are evaluated and the local fluid height increment dh is computed. The fluid height is then updated as h(t+1)=h(t)+Δtdh. For selecting values for the time step Δt and spatial discretization step Δx, the stability factor is Δt<CΔx⁴, where C is a constant.

As illustrated in this example, the brushstroke module 208 generates a brushstroke 118 based on a shape of the stroke 122 that simulates fluid interaction on the canvas 124 based on the gravity feature 126. For instance, the brushstroke 118 of the painting of the pumpkin now has a flow edge 502 that mimics a watercolor brushstroke. The flow edge 502 depicts watercolor paint flowing into the divots of the canvas 124, creating a staggered-looking edge.

As part of this, the fluid flow module 116 simulates surface tension in some examples to generate the brushstroke 118. This is because surface tension is relevant to how the watercolor paint interacts with the canvas 124. Water has a high surface tension, causing it to form cohesive droplets rather than spreading evenly. When water is mixed with pigments to create watercolor paint, this surface tension influences how the paint flows, holding the pigment particles together while resisting spreading. The texture and absorbency of the canvas 124 further affect this interaction. On highly absorbent paper, the dominance of surface tension is reduced as the paint sinks into the fibers, resulting in less dramatic spreading. Conversely, smoother, less absorbent paper enhances surface tension effects, leading to more prominent spreading and puddling. Because different fluid-based pigments have different levels of absorbency and other factors related to surface tension, the received selection of the fluid-based pigment further affects the brushstroke 118 in some examples. For example, the fluid flow module 116 leverages the algorithm 206 to factor the surface tension into the determination of how the watercolor paint interacts with the canvas 124 to generate the brushstroke 118.

In some examples, the algorithm 206 is a machine learning model trained to determine the gravity feature 126 and to generate the brushstroke 118 based on the gravity feature 126. For example, the machine learning model is trained on real-life examples of fluid flow related to different pigments, including watercolor paint, on different canvas types. For instance, the different canvas types have different geometries, including texture and/or orientation. By observing fluid flow behavior on the different canvas types, the machine learning model is trained to predict the brushstroke 118 for the gravity feature 126 corresponding to the different canvas types.

Additionally, in some examples the fluid flow module 116 generates the brushstroke 118 as a frame-by-frame simulation based on a continuous analysis of the stroke 122. For instance, the fluid flow module 116 receives live input of the stroke 122 and generates the brushstroke 118 in real-time as the stroke 122 is drawn.

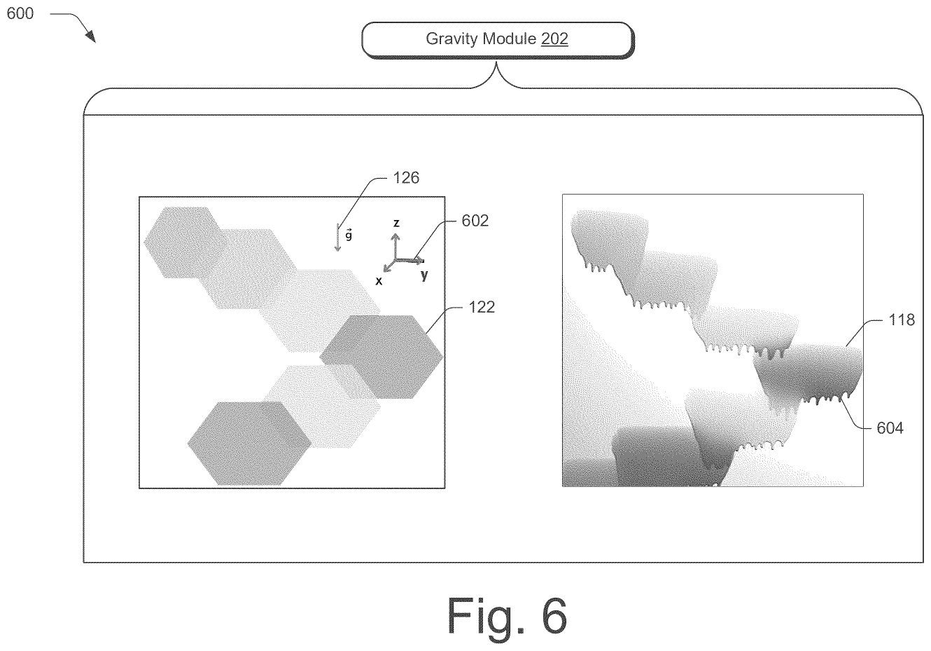

FIG. 6 depicts an example 600 of generating a brushstroke based on the gravity feature and an orientation of the virtual canvas. The example 600 is an alternative of the examples described with respect to FIGS. 3-5.

As illustrated, the fluid flow module 116 receives an input 120 including a stroke 122 on a canvas 124. In this example, the stroke 122 is a paint stroke that is part of a virtual painting of a series of hexagons. The virtual painting in this example includes multiple strokes of various shapes, sizes, and colors received as input as part of a drawing application. The hexagons are painted in multiple different colors and are overlapping in areas. The user interface 110, for instance, displays a canvas 124 configured for drawing or painting, in addition to various selectable colors and widths for drawing or painting the stroke 122. For example, the stroke 122 corresponds to a swipe, tap, drag, or other motion received via a touch screen display, an analog mouse, or other computing input mechanism.

In this example, the user interface 110 is also configured to receive a selection of an orientation 602 of the canvas 124. The orientation 602 indicates a position and/or angle of the canvas 124. As illustrated in this example, for instance, the canvas 124 is positioned vertically at an incline. In some examples, the fluid flow module 116 presents options of selection of the orientation 602 for the canvas 124 of the simulated watercolor painting. For instance, the fluid flow module 116 presents selectable options for editing an angle of the canvas 124 in the user interface 110 (e.g., tilting the canvas 124 in a grid environment in the user interface 110) to specify a vertical, horizontal, or angled orientation of the canvas 124. In other examples, the fluid flow module 116 receives a description including a text command or prompt describing the orientation 602 (e.g., “vertical canvas”).

Additionally, in this example the input 120 indicates a desire to generate strokes that have the appearance of watercolor paint or other fluid-based pigment. For example, the stroke 122 currently has a shape with smooth edges that approximately correspond to a hexagon drawn by a user on the user interface 110. However, the user desires the stroke 122 to have an organic appearance that simulates watercolor paint, which is characterized by having dripping, which is affected by the orientation 602 in this example. This is because watercolor paint is water-based and therefore flows unevenly on a painting surface, influenced by the orientation 602 of the painting surface.

To determine the gravity feature 126, the gravity module 202 uses an algorithm 206 configured to analyze geometry of the canvas 124 to determine a gravity map corresponding to the canvas 124. The canvas 124 in this example has an orientation 602 that is vertical, which affects the simulated appearance of the watercolor paint. The gravity feature 126, for instance, indicates a vertical fluid flow direction down the surface of the canvas 124 due to the orientation 602 of the canvas 124.

As illustrated in this example, the brushstroke 118 generates a brushstroke 118 based on a shape of the stroke 122 that simulates fluid interaction on the canvas 124 based on the gravity feature 126. For instance, the brushstroke 118 of the painting of the hexagons now has a dripping edge 604 that mimics a watercolor brushstroke dripping down the surface of the canvas 124 due to the gravity feature 126. For instance, the orientation 602 influences the gravity feature 126 by causing a simulated downward force that draws the simulated fluid watercolor paint to drip down the canvas 124. The dripping edge 604 depicts watercolor paint flows down the surface of the canvas 124 and blends into different colors of different hexagons in this example.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6.

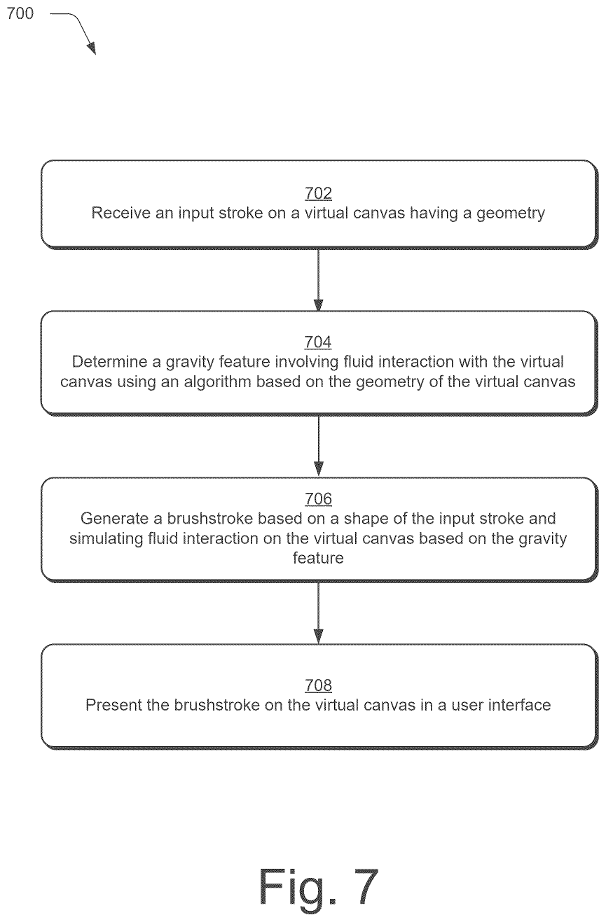

FIG. 7 depicts a procedure 700 in an example implementation of generating brushstrokes with gravity-based fluid flow. At block 702, an input stroke is received on a virtual canvas.

At block 704, a gravity feature 126 involving simulated fluid interaction with the virtual canvas is determined using an algorithm 206 based on a geometry of the virtual canvas. In some examples, the geometry of the virtual canvas describes a texture, and the fluid interaction on the virtual canvas is based on the texture. Some examples further comprise generating a gravity map describing effects of the gravity feature related to sections of the virtual canvas. For instance, the gravity feature 126 is based on an input selection of a texture type for the virtual canvas. Additionally or alternatively, the gravity feature 126 is based on an input selection of an orientation 602 for the virtual canvas.

At block 706, a brushstroke 118 is generated based on a shape of the input stroke and that simulates fluid interaction on the virtual canvas based on the gravity feature 126. In some examples, the fluid interaction on the virtual canvas involves determining simulated surface tension of fluid on the virtual canvas. Additionally or alternatively, the fluid interaction on the virtual canvas is based on properties of an input selection of a virtual fluid for the input stroke.

At block 708, the brushstroke 118 is presented on the virtual canvas in a user interface 110. In some examples, the fluid interaction on the virtual canvas involves determining simulated dripping of virtual fluid based on the gravity feature 126. Additionally, in some examples the brushstroke 118 is a frame-by-frame simulation of the brushstroke based on a continuous analysis of the input stroke.

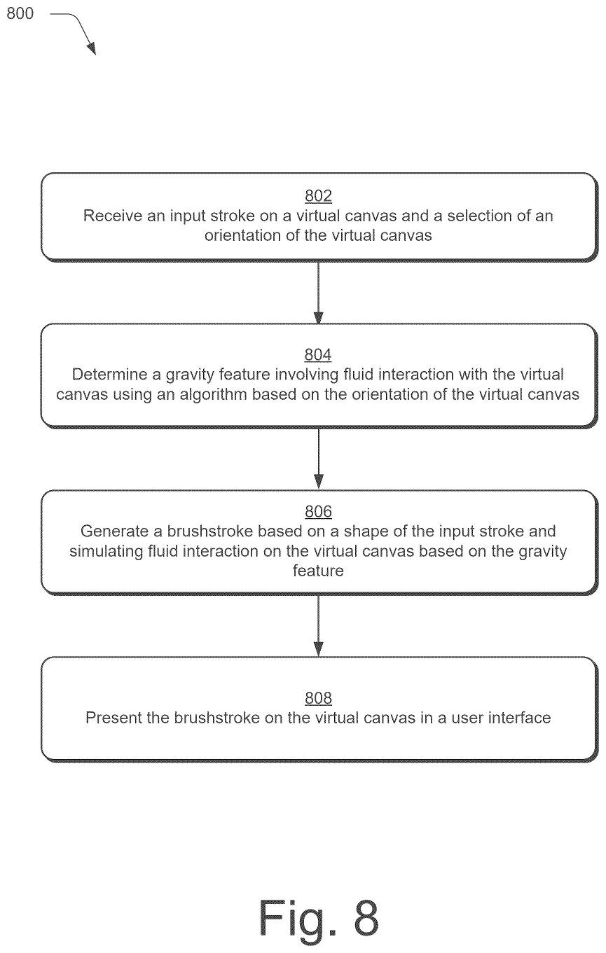

FIG. 8 depicts a procedure 800 in an additional example implementation of generating brushstrokes with gravity-based fluid flow. At block 802, an input stroke is received on a virtual canvas and a selection of an orientation 602 of the virtual canvas.

At block 804, a gravity feature 126 involving simulated fluid interaction with the virtual canvas is determined using an algorithm 206 based on the orientation of the virtual canvas. Some examples are further configured to generate a gravity map describing effects of the gravity feature 126 related to sections of the virtual canvas. For example, the gravity feature 126 is based on an orientation of the virtual canvas, and the orientation of the canvas corresponds to a received angle of incline of the virtual canvas.

At block 806, a brushstroke 118 is generated based on a shape of the input stroke and that simulates fluid interaction on the virtual canvas based on the gravity feature 126. In some examples, the fluid interaction on the virtual canvas involves determining simulated surface tension of fluid on the virtual canvas. For example, the fluid interaction on the virtual canvas involves determining simulated dripping of virtual fluid based on the gravity feature 126. Additionally, in some examples, the virtual canvas has a texture, and the fluid interaction on the virtual canvas is based on the texture.

At block 808, the brushstroke 118 is presented on the virtual canvas in a user interface 110. In some examples, the fluid interaction on the virtual canvas is based on properties of an input selection of a virtual fluid for the input stroke.

### Example System and Device

FIG. 9 illustrates an example system generally at 900 that includes an example computing device 902 that is representative of one or more computing systems and/or devices that implement the various techniques described herein. This is illustrated through inclusion of the fluid flow module 116. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 1114 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized when computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method comprising:
receiving, by a processing device, an input stroke on a virtual canvas;
determining, by the processing device, a gravity feature involving simulated fluid interaction with the virtual canvas using an algorithm based on a geometry of the virtual canvas;
generating, by the processing device, a brushstroke based on a shape of the input stroke and that simulates fluid interaction on the virtual canvas based on the gravity feature; and
presenting, by the processing device, the brushstroke on the virtual canvas in a user interface.

2. The method of claim 1, wherein the geometry of the virtual canvas describes a texture, and the fluid interaction on the virtual canvas is based on the texture.

3. The method of claim 1, further comprising generating a gravity map describing effects of the gravity feature related to sections of the virtual canvas.

4. The method of claim 1, wherein the gravity feature is based on an input selection of a texture type for the virtual canvas.

5. The method of claim 1, wherein the gravity feature is based on an input selection of an orientation for the virtual canvas.

6. The method of claim 1, wherein the fluid interaction on the virtual canvas involves simulated surface tension of fluid on the virtual canvas.

7. The method of claim 1, wherein the fluid interaction on the virtual canvas is based on properties of an input selection of a virtual fluid for the input stroke.

8. The method of claim 1, wherein the fluid interaction on the virtual canvas involves simulated dripping of virtual fluid based on the gravity feature.

9. The method of claim 1, wherein the generating the brushstroke is a frame-by-frame simulation of the brushstroke based on a continuous analysis of the input stroke.

10. A method comprising:
receiving, by a processing device, an input stroke on a virtual canvas and a selection of an orientation of the virtual canvas;
determining, by the processing device, a gravity feature involving simulated fluid interaction with the virtual canvas using an algorithm based on the orientation of the virtual canvas;
generating, by the processing device, a brushstroke based on a shape of the input stroke and that simulates fluid interaction on the virtual canvas based on the gravity feature; and
presenting, by the processing device, the brushstroke on the virtual canvas in a user interface.

11. The method of claim 10, wherein the orientation of the virtual canvas is based on a received indication of an angle of incline of the virtual canvas.

12. The method of claim 10, further comprising generating a gravity map describing effects of the gravity feature related to sections of the virtual canvas.

13. The method of claim 10, wherein the gravity feature is based on an input selection of a texture type for the virtual canvas.

14. The method of claim 10, wherein the fluid interaction on the virtual canvas involves simulated surface tension of fluid on the virtual canvas.

15. The method of claim 10, wherein the fluid interaction on the virtual canvas is based on properties of an input selection of a virtual fluid for the input stroke.

16. The method of claim 10, wherein the fluid interaction on the virtual canvas involves simulated dripping of virtual fluid based on the gravity feature.

17. A system comprising:
a memory component; and
a processing device coupled to the memory component, the processing device to perform operations comprising:
receiving an input stroke on a virtual canvas;
determining a gravity feature involving simulated fluid interaction with the virtual canvas using an algorithm based on a geometry of the virtual canvas;
generating a brushstroke based on a shape of the input stroke and that simulates fluid interaction on the virtual canvas based on the gravity feature; and
presenting the brushstroke on the virtual canvas in a user interface.

18. The system of claim 17, wherein the geometry of the virtual canvas describes a texture, and the fluid interaction on the virtual canvas is based on the texture.

19. The system of claim 17, further comprising generating a gravity map describing effects of the gravity feature related to sections of the virtual canvas.

20. The system of claim 17, wherein the fluid interaction on the virtual canvas involves simulated surface tension of fluid on the virtual canvas.
